(19) United States
(12) Patent Application Publication
(10) Pub. No.: US 2004/0221091 A1
(43) Pub. Date: Nov. 4, 2004

(54) AN IC CARD HAVING A DEDICATED WRITE CONTROLLER FOR WRITING TO INCORPORATED EEPROM ON THE CARD

(76) Inventor: NAOKI MITSUISHI, KODAIRA-SHI (JP)

Correspondence Address: MATTINGLY, STANGER & MALUR, P.C., 1800 DIAGONAL ROAD, SUITE 370, ALEXANDRIA, VA, 22314, US

(21) Appl. No.: 09/240,975

(22) Filed: Jan. 29, 1999

Related U.S. Application Data
(63) Continuation of application No. 07/344,455, filed on Apr. 27, 1989, now abandoned.
Application No. 07/344,455 is a continuation of application No. 07/029,750, filed on Mar. 24, 1987, now abandoned.

(30) Foreign Application Priority Data
Mar. 26, 1986 (JP) 61-65739

(51) Int. Cl. G06F 12/00

(52) U.S. Cl. 711/103; 711/115; 711/165; 711/163

(57) ABSTRACT

A single chip type microcomputer includes at least a central processing unit (CPU), a random-access memory (RAM), a mask read-only memory (CPU) and an electrically writable ROM such as an electrically erasable and programmable read-only memory (EEP-ROM). The electrically writable ROM stores both the user program and data to be preserved. The microcomputer includes further a memory for storing a write control program for controlling the write operation to the writable ROM, and the electrically writable ROM and the memory are disposed at mutually different address positions on the address space of CPU. The proportion of size of the user program region and the data region in the writable ROM can be selected in a free proportion.

### BACKGROUND OF THE INVENTION

This invention relates generally to microcomputer technique, and more particularly to techniques which are effective when applied to a single chip type microcomputers with a built-in electrically writable ROM, such as an EEP-ROM (Electrically Erasable and Programmable Read-Only Memory). For instance, the present invention relates to techniques which can be applied effectively to a microcomputer incorporated in an IC card.

The so-called “IC card” has drawn an increasing attention in recent years as an improved replacement for magnetic cards such as those used with automated teller machines, credit cards, electronic locks, or the like. Such cards present encoded, machine-readable data, often tapered to a particular card carrier. In the magnetic cards, the information is generally encoded as a series of magnetic signals embedded on a ferric-type coating strip on the card.

The magnetic cards suffer from limited data storage capacity, as well as relative ease of access to the encoded data for unauthorized viewing or modification.

A first improvement to the magnetic card was presented by “memory cards.” As disclosed in Japanese Patent Publication No. 19665/1981, typical memory cards incorporate therein a EPROM (ultraviolet “UV” erasable type programmable ROM) which stores data such as ID (identification) codes.

The EPROM memory cards suffer from an inability to allow for alterations to existing data. Erasure may involve exposure of the entire chip to ultraviolet light of a predetermined strength, for a not insubstantial period of time. Such properties substantially impair the constant revisions and updates which are often desirable for stored data.

The IC card provides a means for substantially increasing the amount of data which may be stored, as well as allowing for selective modification thereof.

In addition, it is often desirable to include encryption or encoding schemes which will substantially impair unauthorized access to data stored on the IC card. Such serves to improve confidentiality of data to prevent unauthorized access to certain locations or to maintain integrity of information to be relied upon later. If a ROM device were to be used to accomplish encryption, an entire chip would have to be replaced periodically as the particular encryption schemes become known.

It is therefore desirable to provide a means for ease of semi-permanent storage of data, as well as a program allowing access thereto and manipulation thereof. It is also desirable to have a method for storage of and access to the data.

The present invention provides a microcomputer which can immediately satisfy diversified requirements for data storage and manipulation which includes the ability to semi-permanently preserve data as necessary. A preferred embodiment affords the ability to provide all functions on a single chip.

It is therefore an object of the present invention to provide technique which can improve the efficiency of hardware resources while keeping the advantages of the microcomputer described in that it can immediately satisfy diversified user's requirements for specification and application, and can further preserve semi-permanently data in EEP-ROM whenever necessary.

### SUMMARY OF THE INVENTION

In accordance with the present invention there is provided a means for selective, semi-permanent storage of data or programs to a non-volatile memory. A central processing unit controls reads and writes of a program or data to the non-volatile memory in accordance with a data transfer program.

In accordance with another aspect of the present invention, a microcomputer which includes a non-volatile memory into which a user program and data may be written electrically, and a memory for storing a write control program for controlling the write operation to the non-volatile memory which is comprised of electrically programmable ROM (“EEP-ROM”). The EEP-ROM and the memory are disposed at mutually different positions on the address space of a CPU.

In accordance with a more limited aspect of the present invention, a program means for controlling the central processing unit to effect a write operation into the EEP-ROM is provided. In one embodiment, this program means is embedded in a mask ROM.

In accordance with another aspect of the present invention, the CPU is caused to jump to the memory containing the write control program only when data is to be written into the electrically writable ROM. The CPU can therefore execute a predetermined write control process during the write operation to the electrically writable ROM.

In accordance with another aspect of the present invention, the user program region and the data region are disposed in one electrically writable ROM and the proportion of the size of each region is arbitrarily selected. The scale of the hardware construction is thereby reduced, and the utilization efficiency of the hardware resources are improved while keeping the advantages that various users' requirements for specifications and applications can be satisfied immediately. Additionally, data may be preserved semi-permanently in ROM as necessary.

### BRIEF DESCRIPTION OF THE INVENTION

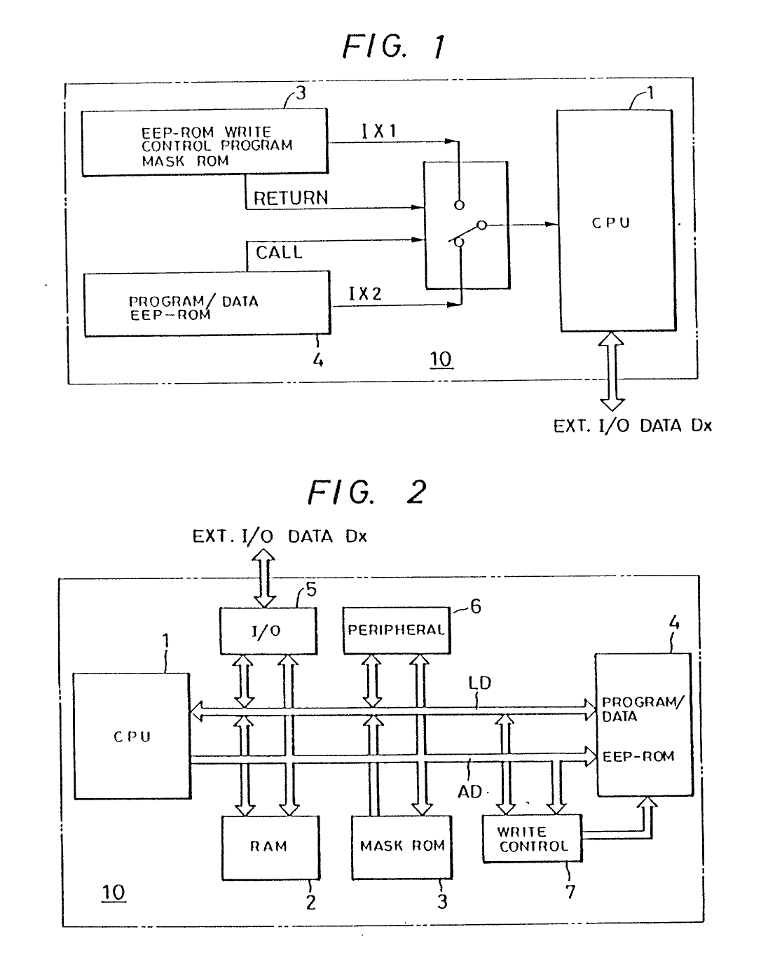

FIG. 1 is a block diagram showing the principal portions of a microcomputer with a built-in EEP-ROM;

FIG. 2 is a block diagram showing an example of the overall construction of the microcomputer shown in FIG. 1;

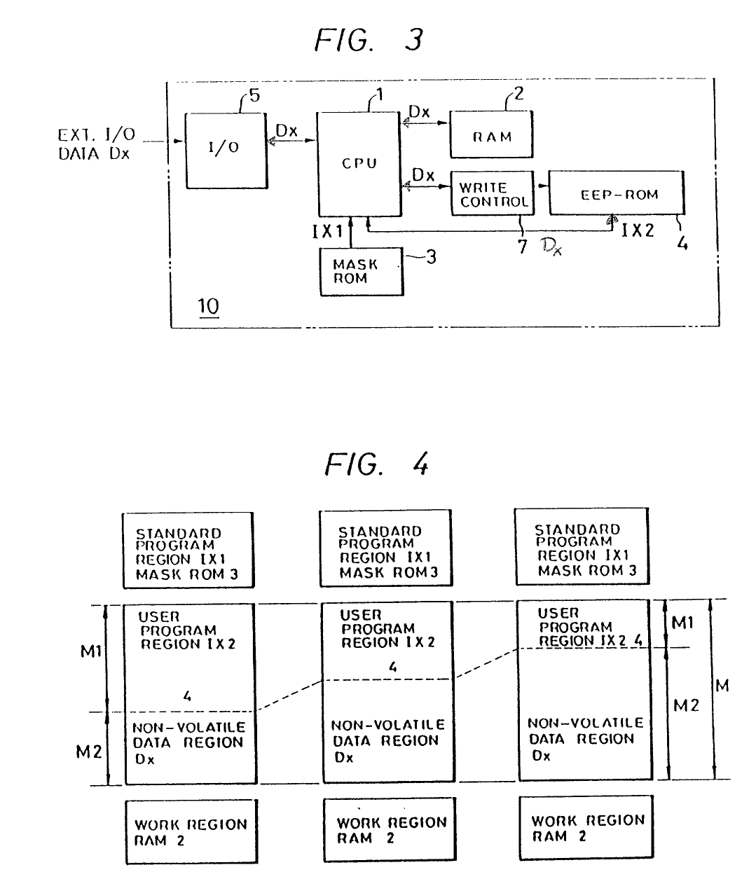

FIG. 3 is a block diagram showing the flow of data in the microcomputer shown in FIG. 2;

FIG. 4 is an address map showing three possible conditions of the address spaced of CPU in the microcomputer shown in FIG. 2;

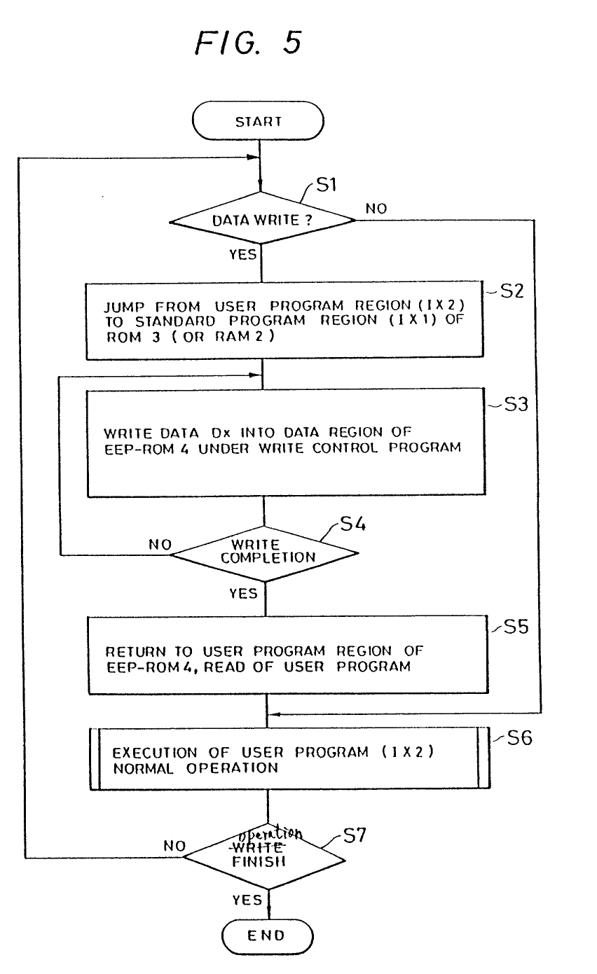

FIG. 5 is a flowchart showing an example of the operation of the microcomputer shown in FIG. 2;

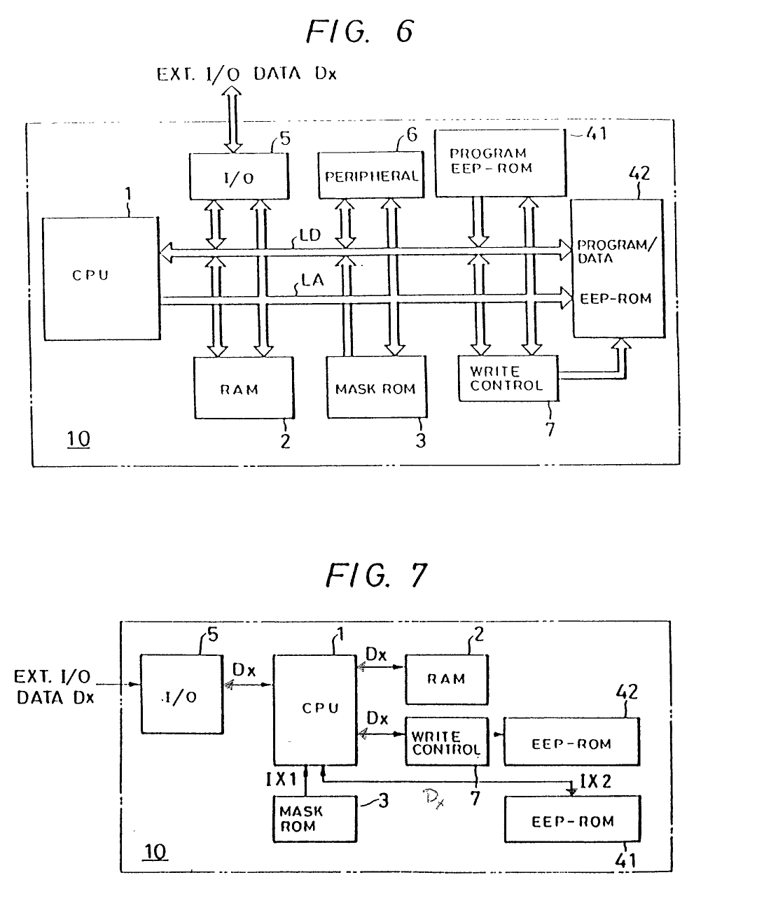

FIG. 6 is a block diagram showing the construction of the micrcomputer with a built-in EEP-ROM in an alternate embodiment of the present invention;

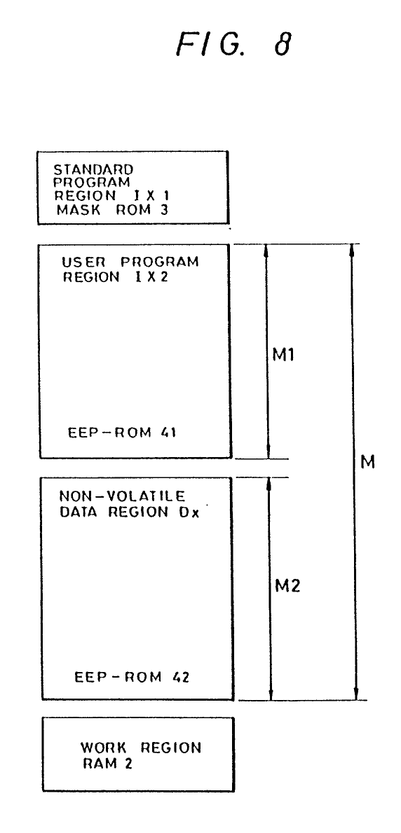

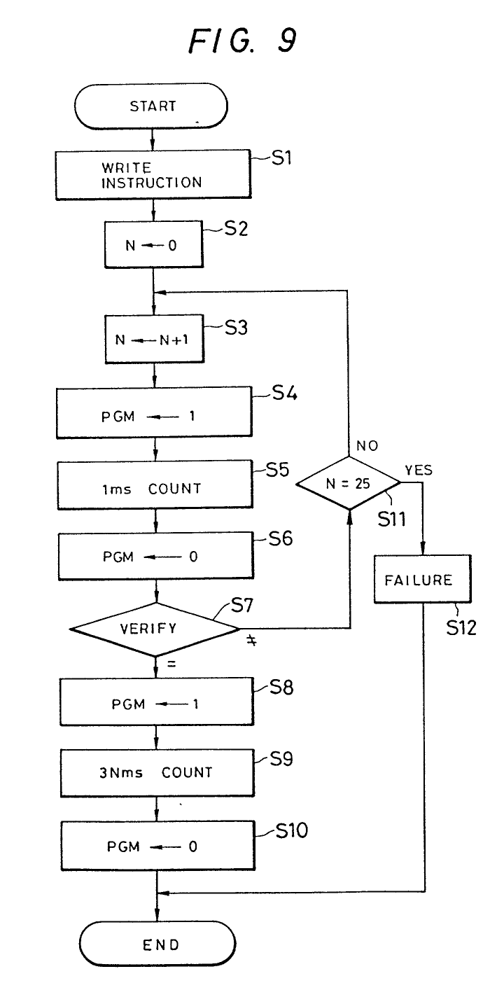

FIG. 7 is a block diagram showing the flow of data in the microcomputer shown in FIG. 6; and

FIG. 8 is an address map showing the conditions of the address space of CPU in the microcomputer shown in FIG. 6.

### DESCRIPTION OF THE PREFERRED AND ALTERNATE EMBODIMENTS

Hereinafter, various embodiments of the present invention will be described with reference to the accompanying drawings. Like reference numerals will be used throughout the drawings to identify the same or like constituents.

FIG. 1 shows the principal portions of the micrcomputer 10 in accordance with one embodiment of the present invention. The microcomputer is designed to provide data transfer to and from a contiguous memory as will be described below. Data transfer operations include reads or writes to or from the memory, movement of data from one memory location to another, or revision of stored data in accordance with other data.

Data transfers are made in conjunction with an external data device, which may be a data source, which the microcomputer operates. Suitable means are provided, such as a parallel interface, a serial interface, or an edge card connector, to place the microcomputer in data communication therewith.

The microcomputer 10, whose principal portions are shown in FIG. 1, is of a single chip type. Included is a CPU 1, and EEP-ROM 4 into which both a user program Ix2 and data to be preserved are written in arbitrary proportion. The micrcomputer 10 also includes a so-called mask ROM 3 which has fixed therein a program for effecting a write control operation of a data transfer which provides for writing and overwriting of data into EEP-ROM 4. This is part of the standard program Ix1. Generally, the time necessary for the write operation to EEP-ROM is about 1,000 times a mean instruction execution time of the CPU.

Mask ROMs can generally be fabricated in a smaller area than EEP-ROMs having the same capacity. Accordingly, overall size of the semiconductor chip can be reduced by utilizing the mask ROM 3 instead of storing all the programs in EEP-ROM 4. Additionally, mask ROM 3 may store only the write control program or may store the aforementioned standard program routine.

The write control program includes a program for starting operation of the write control circuit 7 or a program for detecting completion of the write operation. EEP-ROM 4 and mask ROM 3 are disposed at mutually different address positions on the address space of CPU 1.

The switch shown in FIG. 1 is illustrative only, and is used to identify that a program controlling execution of the CPU 1 is tranferred to mask ROM 3 by a call instruction at the time of a write operation, and is returned to a program in EEP-ROM 4 by return instruction after completion of the write operation.

A call instruction to a specific routine in the mask ROM 3 can be written into EEP-ROM 4 in place of the write control program to EEP-ROM 4. Correspondingly, a return instruction to EEP-ROM 4 can be written at the end of the write control program into the mask ROM 3 together with the write control program for EEP-ROM 4.

FIG. 2 shows one embodiment of the overall construction of the microcomputer 10 shown in FIG. 1. As shown in the drawing, the microcomputer 10 incorporates therein, in addition to the elements of FIG. 1, a RAM 2 providing the work region of CPU 1, an I/O unit (input/output unit) 5 for the exchange of the data Dx to and from the outside, a peripheral circuit 6, and an EEP-ROM write control unit 7. Since the microcomputer includes these constituent elements, it is suitable as a single chip type microcomputer to be incorporated in the IC card. These units (1, 7) of the microcomputer 10 are connected to one another through an address bus AD and a data bus LD.

As noted above, the RAM 2 provides a work region or scratch pad of easily readable and writable RAM for use of the central processing unit. If the quantity of the data to be written is great, the data prepared in a predetermined region in RAM 2 overflow may be transferred sequentially to EEP-ROM 4. Such is accomplished under the control of either the standard program or the user program.

Control signals for the memories and suitable peripheral circuits are well within the abilities of one of ordinary skill in the art, and are omitted from the drawing for ease of illustration.

FIG. 3 shows the flow of data Dx in the microcomputer of FIG. 2. As shown in the drawing, the exchange of data Dx to and from the outside is effected through the CPU 1. Therefore, the built-in software cannot be accessed unless a “key” of suitable software is used.

FIG. 4 shows three possible address apportionments of memory, illustrated by memory maps. As shown in the drawing, both the user program region M1 and the data region M2 are allotted in a suitable proportion to the memory region M of EEP-ROM 4.

FIG. 5 shows the flowchart of an example of the processing operation as a write control for EEP-ROM 4 is made called for by CPU 1.

In FIG. 2 and FIG. 5 the CPU 1 reads, instruction by instruction, the program Ix2 written into the user program region Ml and executes a predetermined processing operation (step S6).

If it becomes necessary to preserve data Dx into EEP-ROM 4 during this process (step S1), the CPU 1 jumps to the leading address of the write control program in the standard program region Ix1, preferably stored in mask ROM 3, by call a instruction (step S2). The write control processing of EEP-ROM 4 is executed in accordance with the write control program (step S3). In this manner, a write to EEP-ROM 4 is conducted through the EEP-ROM write control unit 7. During this write operation, the EEP-ROM 4 is electrically isolated from the CPU 1 by a suitable electric switch or gate means, such as a tri-state buffer.

The CPU 1 judges completion of the write operation on the basis of a flag generated from the write control unit 7, or an interrupt request (step 4). Then, CPU 1 returns from mask ROM 3 to the program region M1 of EEP-ROM 4 and recommences the read operation of the user program from next address to the address at the time of jump (step S5). CPU 1 keeps executing the user program until the processing is complete or until a next data write request occurs (step S6).

As described above, the user program region M1 and the data region M2 are preferably disposed in one EEP-ROM 4. At the same time, since the sizes of both regions M1 and M2 can be varied in proportion. The memory region M can be interchanged and used efficiently between the user program region M1 and the data region M2 by, for example, increasing the size of the program region M1 and reducing the size of the data region M2 or vice versa, as can be seen from the three examples shown in FIG. 4. Such an apportionment provides for functionality of the device even if the size of the memory region M of EEP-ROM as a whole is not substantial.

Accordingly, the present invention allows for the construction scale of the hardware to be reduced, and efficient utilization of hardware resources, while advantageously providing for immediate satisfaction of user's diversified specifications. Data can be also preserved semi-permanently in EEP-ROM 4 as may be necessary.

It should be noted that the return to the user program upon completion of the write operation to EEP-ROM need not use the flag generated from the write control unit 7, or the interrupt request, as in the embodiment described above. For example, it is possible to employ a circuit construction wherein a suitable work register in CPU 1 is operated simultaneously with the start of a write operation to EEP-ROM, and is used as a counter or timer which is updated in a predetermined period during its operation. A return operation is then executed when the content of such a work register reaches a predetermined value. In other words, a construction is envisioned wherein CPU 1 counts a predicted and predetermined write time and checks, by means of a software, the point of completion of the write operation to EEP-ROM. In this case, setting of the write time and the control of the subsequent return operation can be made by means of hardware using a dedicated circuit, such as a timer circuit.

The user program in the embodiment described above further includes a construction wherein the CPU 1 is stopped by an external control and the write operation is directly made to the user program region M1 of EEP-ROM 3 from an exterior data source with which the CPU is in data communcation.

This write operation of the user program may be effected by a construction wherein the CPU 1 receives a program from outside through the I/O unit 5 in accordance with the program of mask ROM 3, and then makes the write operation to the user program region M1 of EEP-ROM 4. Since such a use does not allow direct access to the built-in EEP-ROM 4 from outside, the function of keeping secrecy is improved and the suitability of the microcomputer for the single chip type microcomputer to be incorporated in the IC card is further improved.

Whether or not the write operation to the user program 4 has already been made is judged by a flag which is disposed inside EEP-ROM 4. The start address after reset of CPU 1 can also be changed in accordance with the status of this flag.

It will be appreciated that while EEP-ROMs are desirable as non-volatile memory, the above-described organization may be implemented in UV-EPROM memory.

In the embodiment described above, the write operation is made by the write control circuit 7 for a predetermined period, though other analagous methods may be employed.

An alternate embodiment of a suitable microcomputer shown in FIG. 6. This embodiment is of a single chip type with a built-in EEP-ROM, and includes a CPU (central processing unit) 1, RAM (random access memory) 2, mask ROM (fixed memory ROM) 3, EEP-ROMs 41, 42, I/O (input/output unit) 5, peripheral circuit 6 and EEP-ROM write control unit 7 inside the same semiconductor chip. Each unit (1, 7) is connected to the other by address bus LA and data bus LD.

This single chip type microcomputer 10 may be used in conjunction with an IC card. The exchange of data Dx to and from outside is all effected through CPU 1 as shown in FIG. 7. Also shown is the flow of data Dx in the microcomputer 10 of FIG. 6 This microcomputer can similarly be implemented in such a fashion that unless a “key” of a suitable software in the EEP-ROM or the CPU is used, the built-in software cannot be accessed.

In FIGS. 6 and 7, EEP-ROMs 41 and 42 are generally equivalent, and are disposed independently of each other. One (41) of them is used as a so-called “user program region” (M1) as shown in FIG. 8, into which a program, prepared freely by the user, can be written in advance. A write operation of this program is made by stopping the CPU from an external control signal and writing the data directly into EEP-ROM 41. A suitable programming method for such a PROM is found in “Hitachi Microcomputer Data Book, 8-bit Single Chip”, pp. 823-865, published in August, 1984 by Hitachi, Ltd., which is incorporated herein by reference. This alternate embodiment advantageously eliminates the necessity for rewriting the mask ROM in the production process, and can cope instantly with the diversified applications by the users.

Furthermore, suitable means may be provided to inhibit re-write or read to and from this EEP-ROM 41 after programming is finished. This allows the built-in software to be protected effectively. The other EEP-ROM 42 is used as a data region (M2). Here, those data Dx which must be preserved among the input/output data managed by CPU 1 are written instantaneously whenever necessary. A write operation to this EEP-ROM 42 is effected through a write control circuit 7 which is controlled by CPU 1. During this write period, EEP-ROM 42 is electrically cut off from CPU 1 and both write and read operations to and from EEP-ROM 42 are not possible.

The CPU 1 reads, instruction by instruction, a user program Ix2 stored in the program storage EEP-ROM 41, and executes a predetermined processing operation. When it becomes necessary during this processing to write preservation data Dx into the data storage EEP-ROM 42, a write operation to this EEP-ROM 42 is made through the EEP-ROM write control unit 7. During execution of the Ix2 program, reference is made, whenever necessary, to a second program routine (or a program module) prepared in advance as a standard program Ix1. This second program is stored in the mask ROM 3. The Ix1 program routine may comprise a software timer, a division program, or other various programs prepared in accordance with various intended applications. Overall processing is, however, conducted in accordance with the user program written into EEP-ROM 41.

The EEP-ROM write control unit 7 shown in FIG. 7 makes a write operation to the EEP-ROM 42 under the controlled of the program written into one of the EEP-ROMs. The remaining EEP-ROM 42 is, similarly to the preferred embodiment, electrically cut off from CPU 1 while the write operation is being carried out by its counterpart.

The microcomputer 10 of the alternate embodiment described above requires two mutually independent EEP-ROMs 41 and 42 in order to write the user program Ix2 and to store the data Dx to be preserved. If only one EEP-ROM is used, read access to the EEP-ROM cannot be made while the write operation is made to it, as the next instruction to be executed by CPU 1 cannot then be read out. The program and the data are therefore stored in the mutually independent EEP-ROMs 41 and 42. While the instruction is being read out from one (41) of the EEP-ROMs, the write control of the other (42) is made on the basis of the instruction read out from the former.

Since in this embodiment, the two mutually independent EEP-ROMs 41, 42 must be used in order to satisfy diversified user's requirements for specifications, both must be large enough to handle all applications. This capacity is necessary to satisfy such requirements as large program size, even though data storage requirements may be small, or alternatively, large data storage requirements, though the program size may be small. Even if both EEP-ROMs 41, 42 have a sufficient memory capacity, the memory capacity is not always used fully and hence waste is likely to occur.

Each of these EEP-ROMs 41, 42 includes a sense amplifier, circuits for data input/output such as a driver circuit, and a peripheral circuit consisting of an address selection circuit with its corresponding memory array. Therefore, if a plurality of EEP-ROMs are formed independently of one another, peripheral circuits such as the sense amplifier and the driver must be disposed inside the respective EEP-ROM. Hence, a greater number of circuit elements become necessary and increase the overall size of EEP-ROM.

A variation to the alternate embodiment includes storage, in EEP-ROM 41 the control program for EEP-ROM 42 and the data to be referred to by the program of EEP-ROM 42, and storage in EEP-ROM 42 the control program for EEP-ROM 41 and the data to be referred to by the program of EEP-ROM 41. Such allows the program storage area and the data storage area in each of EEP-ROMs 41, 42 to become variable. In this case, the afore-mentioned problem of the memory area or size is somewhat mitigated. In this case, however, each EEP-ROM 41, 42 must have the independent peripheral circuits such as the sense amplifier and the decoder circuit, and overall circuit size is increased.

The write time in EP-ROMs in general is longer than in EEP-ROMs. Accordingly, if the write time is constant as In the embodiment described above, the response time will increase when the microcomputer is incorporated in the IC card. In this case, an unnecessarily long write time is necessary because the write time is set in consideration of a worst case, due to process variances of EP-ROM devices.

It is contemplated that a long write time may be improved by improving the above write control program.

Among the effects brought forth by the preferred embodiment of the present invention, the following will describe typical examples.

In a microcomputer with a built-in EEP-ROM, the user program region and the data region can be dispoed in one EEP-ROM and their sizes can be selected in proportion. Accordingly, the scale of the hardware construction can be reduced and the utilization efficiency of the hardware resources can be improved while keeping the advantages that various users' requirements for specifications and applications can be immediately satisfied, and the data Dx can be preserved semi-permanently in EEP-ROM whenever necessary.

When the present invention is applied to a single chip type microcomputer to be incorporated in the IC card, the strength of the IC card can be improved due to the reduction of the size of the semiconductor chip.

Although the present invention has thus been described with reference to the preferred embodiment thereof, the invention is not particularly limited thereto but can be changed or modified in various forms without departing from the scope and spirit thereof. For example, when the write control program is stored in advance in mask ROM 3 or EEP-ROM 4 and when the write operation to EEP-ROM 4 is made, the write control program may be tranferred to RAM 2 in order to let CPU 1 execute it.

Although the description given above illustrates the example wherein the present invention is applied to the single chip type microcomputer for the IC card, the present invention is not particularly limited thereto but can be applied, too, to a board type microcomputer.

In other words, the present invention can be applied to microcomputers of the type wherein the program and the data are stored at least in EEP-ROM.

1-20. (Canceled)

21. A microcomputer comprising:
an electrically programmable ROM which has a first region to store a user program therein and a second region to store data therein;
a memory which stores a write control program for a writing to the electrically programmable ROM; and
a CPU which executes the user program and the write control program,
wherein the electrically programmable ROM and the memory are disposed at mutually different address positions,
wherein the user program includes a first instruction which changes a process of the CPU executing the user program to a process that controls a writing of the electrically programmable ROM based on the write control program stored in the memory, and
wherein the write control program includes a second instruction which returns the CPU to the process based on the executing of the user program stored in the electrically programmable ROM after completion of the process that controls the writing of the electrically programmable ROM.

22. A microcomputer according to claim 21,
wherein the memory which stores a write control program is a mask ROM.

23. A microcomputer according to claim 21,
wherein the memory which stores a write control program is a RAM that receives the write control program from the electrically programmable ROM.
